(19) United States
(12) Patent Application Publication
(10) Pub. No.: US 2017/0225941 A1
(43) Pub. Date: Aug. 10, 2017

(54) RBF Equine Training Crop

(71) Applicant: Patrick A. Corrigan, Tolland, CT (US)

(72) Inventor: Patrick A. Corrigan, Tolland, CT (US)

(21) Appl. No.: 14/943,266

(22) Filed: Feb. 4, 2016

(51) Int. Cl. B68B 11/00; A01K 15/02; B68B 99/00

(52) U.S. Cl. CPC B68B 11/00; B68B 99/00; A01K 15/02

(57) ABSTRACT

A combination crop and spur used for training any discipline of a horse. The crop allows you to make contact with all areas of the horse's body while making the necessary training adjustments in each individual situation. The Beauty of the RBF Equine Training Crop is it allows a horse to focus and react to the necessary training adjustments with lightest touch of the skin.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

### BRIEF SUMMARY OF THE INVENTION

The disclosure provides a riding crop for controlling the front and rear quarters of a horse. The crop can be used while riding or on the ground doing hand work.

The riding crop includes a rubber handle that is attached to a tapered shaft of a crop at the top of the shaft. The bottom of the shaft has a harness leather end which is laced onto the shaft. This is all done by US Whip. Then they are shipped to us to finish the assembly of the spur rowel which requires a V cut to center of the harness leather end. Then a metal sleeve is put in each side to act as a guide for the rowel which sits in the center of the leather flat. A screw and locking nut is used to hold everything in place.

An advantage of the described training crop that is it allows you to make contact with all areas of the horse's body while making the necessary training adjustments in each individual situation. The RBF Equine Training Crop allows the rider to have better timing, lightness of a correction, focus and better consistence while correcting and to aide in using a better leg and hand

### BRIEF DESCRIPTION OF THE SEVERAL VIEWS OF THE DRAWING(S)

FIG. 1: shows the crop configuration

FIG. 2: shows the crop with the polyethylene nylon tubing.

FIG. 3: shows the end portion of the crop.

FIG. 4: shows the crop with rowel feature.

FIG. 5: shows the crop with fiberglass shaft

### DETAILED DESCRIPTION OF THE INVENTION

The RBF Equine Training Crop is a flexible whip featuring a single rowel end used for training any discipline of horse. The crop allows you to make contact with all areas of the horse's body while making the necessary training adjustments in each individual situation. The RBF Equine Training Crop allows the rider to have better timing, lightness of a correction, focus and better consistence while correcting and to aide in using a better leg and hand. The RBF Equine Training Crop simulates a fly landing on a specific area of the horse. When a fly lands on a horse, it's the horses' natural instinct to move away from the source of pressure. Horses have a sheet of muscles underlying the skin which enables them to twitch their skin to get rid of flies (or anything that “tickles” or bites them). It's a reflex called the panniculus reflex. The Beauty of the RBF Equine Training Crop is it allows a horse to focus and react to the necessary training adjustments with lightest touch of the skin.

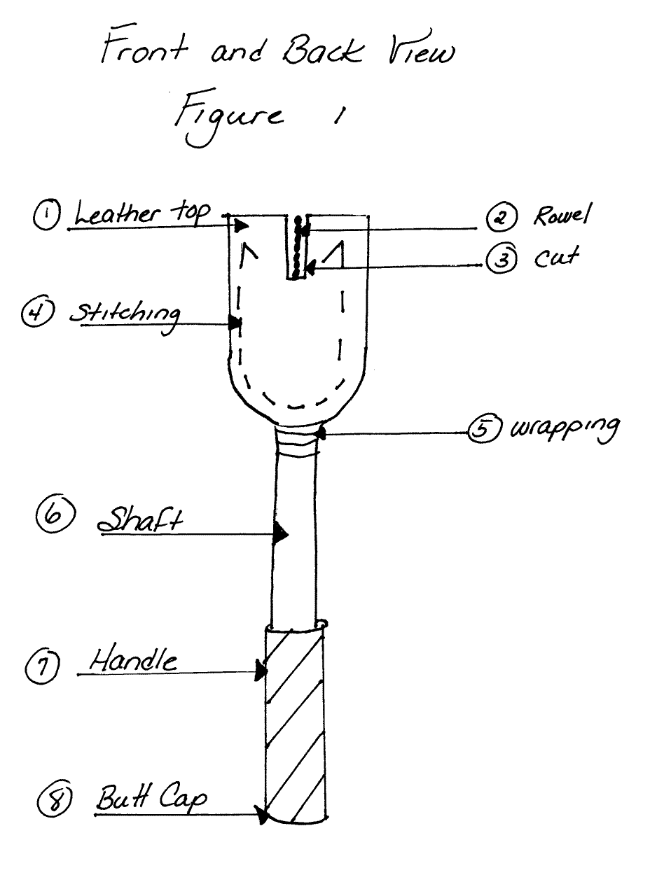

Now referring to FIG. 1: shows the crop configuration wherein like reference numbers refer to like elements, there is illustrated a training crop of the type used by riders to control the front and hind quarters of a horse. The training crop includes a Leather Top made of Golden leather that has been leveled to a seven point five ounce weight/thickness. 2, ½″ long number 10 polyethylene nylon tubing, 5/16″ outside diameter, 3/16″ inside diameter. A 10/24″×1¼″ long slotted round head machine bolt, a nylon think lock nut 10/24″ , A black 1″ nine point rowel. A Fiberglass tapered reinforced extruded shaft, wrapped with a six strand twisted polyester cord over coated with a high gloss black vinyl polymer. The handle size of 6¾× 9/16 inch diameter made of Enflex V 1050A, Vulcanized ethylene/propylene diene & polypropylene blend.

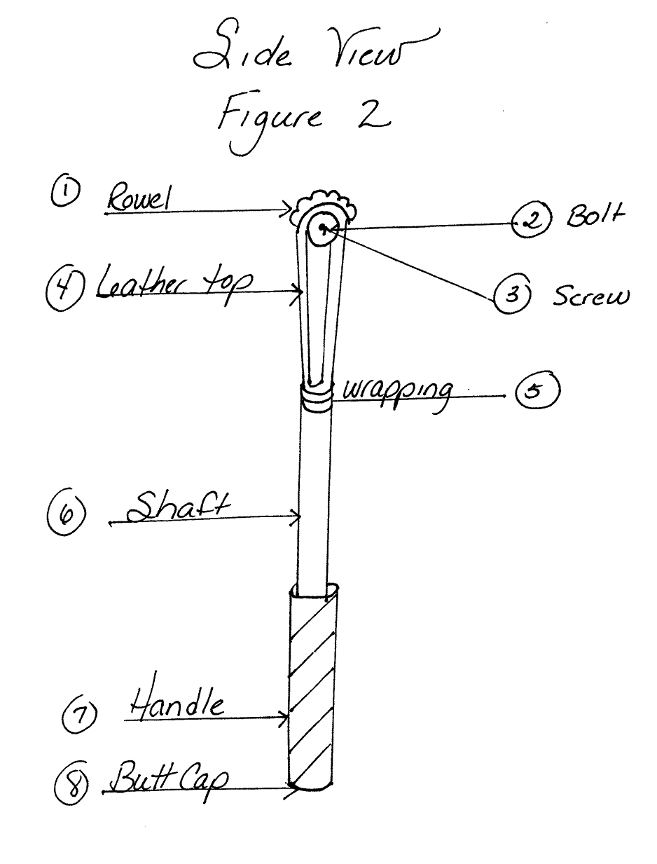

FIG. 2: shows the crop with the polyethylene nylon tubing consisting of 2,½″ long number 10 polyethylene nylon tubing, 5/16″ outside diameter, 3/16″ inside diameter. A 10/24″×1¼″ long slotted round head machine bolt, a nylon think lock nut 10/24″, A black 1″ nine point rowel.

3

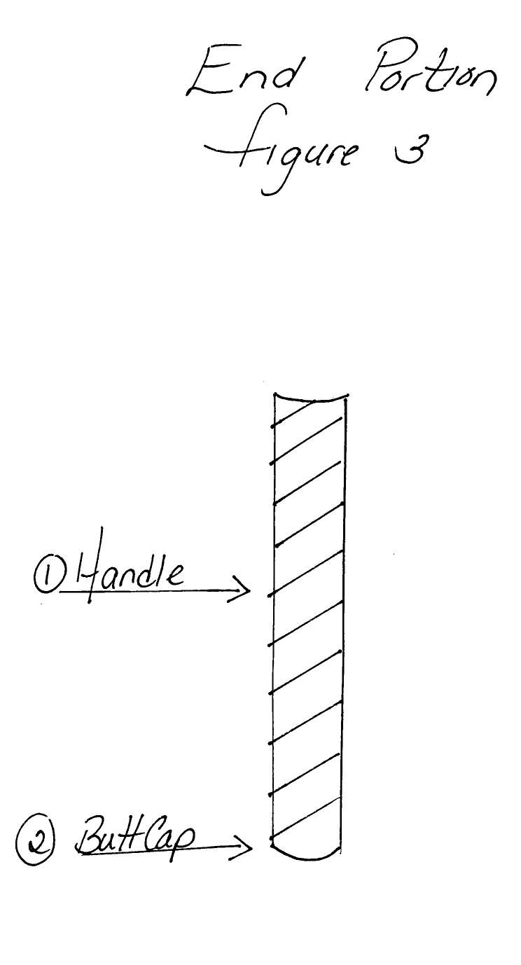

FIG. 3: shows the end portion of the crop. The handle size of 6¾× 9/16 inch diameter made of Enflex V 1050A, Vulcanized ethylene/propylene diene & polypropylene blend.

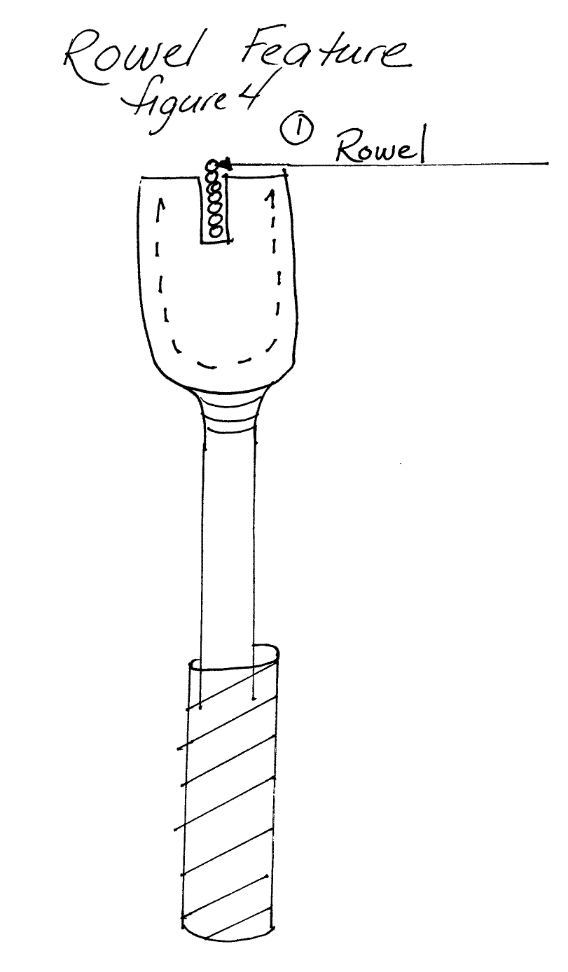

FIG. 4: shows the crop with rowel feature. Leather Top made of Golden leather that has been leveled to a seven point five ounce weight/thickness 2,½″ long number 10 polyethylene nylon tubing, 5/16″ outside diameter, 3/16″ inside diameter. A 10/24″×1¼″ long slotted round head machine bolt, a nylon think lock nut 10/24″, A black 1″ nine point rowel

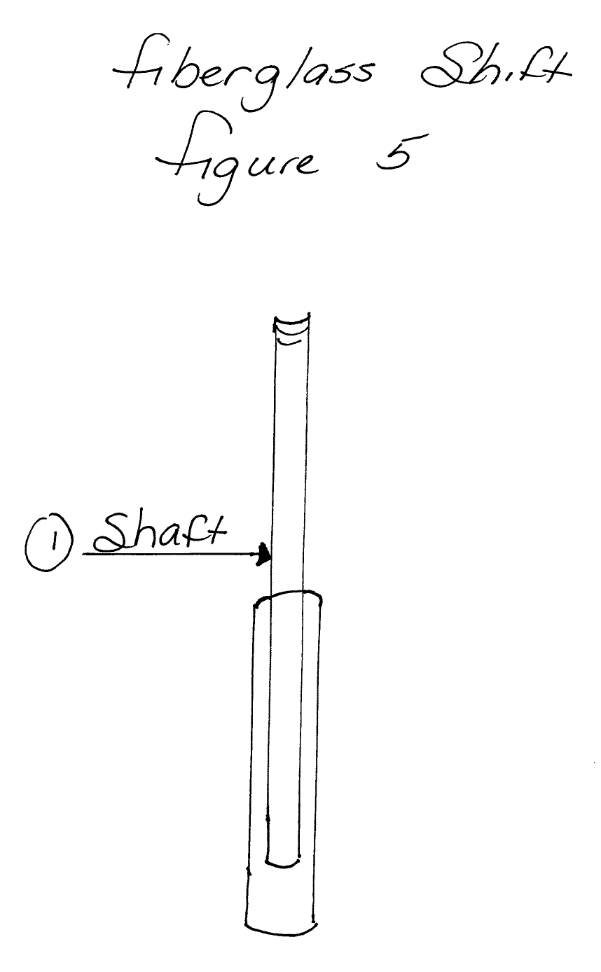

FIG. 5: shows the crop with fiberglass shaft, A Fiberglass tapered reinforced extruded shaft, wrapped with a six strand twisted polyester cord over coated with a high gloss black vinyl polymer.

4

1. An Equine Crop, comprising:
a.) 6¾″× 9/16″ diameter handle;
b.) a fiberglass shaft with a wrapping of 6 strand twisted polyester cord over coated with high gloss black vinyl polymer;
c.) a Leather top with a 1½″×1¼″ cut, a 5/16″ tube and a 10/24″×1¼″ slotted round head machine bolt, topped stitched with a white cotton nylon blend;
d.) a 1″ nine point rowel.

2. An Equine Crop leather top, comprising:
a rowel which attached to the crop adding unique design to the crop, allowing a rider to have better timing, lightness of a correction, focus and better consistence while correcting and to aide in using a better leg and hand further comprising
a. leather Top—Golden leather (belly leather) that has been leveled to a seven point five ounce weight/thickness.
b.) a spacer—2, half inch length—number 10 polyethylene nylon tubing, five sixteenths outside diameter, three sixteenths inside diameter.;
c.) Screw—ten twenty fourth inch × one and one quarter inch long slotted round head machine bolt;
d.) nut—ten twenty fourth inch, nylon thin lock nut
e.) one inch Rowel—Black—nine point

3. An Equine Crop Materials, comprising:
light weight crop material;
a.) stitching—Leather top thread a cotton nylon blend;
b.) Leather Top—Golden leather (belly leather) that has been leveled to a seven point five ounce weight/thickness;
c) wrapping—Black Tying Thread description; A six Strand Twisted Polyester Cord over coated with a high gloss black vinyl polymer;
d.) shaft—Fiberglass reinforced extruded; tapered and ground to spec; butt diameter is three hundred and eight and tip is one hundred and eight of fiberglass rod.;
e.) Handle—Size is six and three quarter inch length × nine sixteenths inch diameter.; made of Enflex V 1050A, Vulcanized ethylene/propylene diene & polypropylene blend.;
f.) spacers—2, half inch length—number 10 polyethylene nylon tubing, five sixteenths outside diameter, three sixteenths inside diameter;
g.) Screw—ten twenty fourth inch × one and one quarter inch long slotted round head machine bolt;
h.) Nut—ten twenty fourth inch, nylon thin lock nut;
i.) One inch Rowel—Black—nine point.

4. A method of making a crop, comprising:
a.) A tapered fiberglass Shaft, wrap with Black Tying Thread—six Strand Twisted Polyester Cord;
b.) attach a handle;
c.) Make a leather top (crop flap);
d.) stitch with a cotton nylon thread;
e.) attach a leather top;
f.) wrap with a Black Tying Thread—Single Strand;
g.) cut a one inch slot in the leather top (crop flap);
h.) insert a half inch spacer on either side of the cut;
i.) insert a screw through a spacer, a rowel and a spacer:
j.) finish by adding a lock nut on screw.
